(19) United States
(12) Patent Application Publication
(10) Pub. No.: US 2021/0374247 A1
(43) Pub. Date: Dec. 2, 2021

(54) UTILIZING DATA PROVENANCE TO DEFEND AGAINST DATA POISONING ATTACKS

(71) Applicant: Intel Corporation, Santa Clara, CA (US)

(72) Inventors: Salmin Sultana, Hillsboro, OR (US); Lawrence Booth, JR., Phoenix, AZ (US); Mic Bowman, Beaverton, OR (US); Jason Martin, Beaverton, OR (US); Micah Sheller, Hillsboro, OR (US)

(73) Assignee: Intel Corporation, Santa Clara, CA (US)

(21) Appl. No.: 17/399,019

(22) Filed: Aug. 10, 2021

Related U.S. Application Data
(60) Provisional application No. 63/063,682, filed on Aug. 10, 2020.

(51) Int. Cl. G06F 21/57

(52) U.S. Cl. CPC G06F 21/57; G06N 3/04

(57) ABSTRACT

The present invention discloses a secure ML pipeline to improve the robustness of ML models against poisoning attacks and utilizing data provenance as a tool. Two components are added to the ML pipeline, a data quality pre-processor, which filters out untrusted training data based on provenance derived features and an audit post-processor, which localizes the malicious source based on training dataset analysis using data provenance.

### CROSS-REFERENCE TO RELATED APPLICATION

This application claims the benefit of and priority to previously filed Provisional U.S. Patent Application Ser. No. 63/063,682 filed Aug. 10, 2020, entitled “Utilizing Data Provenance to Defend against Data Poisoning Attacks”, which is hereby incorporated by reference in its entirety.

### BACKGROUND OF THE INVENTION

Advances in machine learning (ML) have enabled automation for a wide range of applications including, for example, such as smart cities, autonomous systems, and security diagnostics. The security threat to ML systems, however, is a major concern when deployed in real-world applications. ML lifecycle involves two distinct phases: (1) training, which learns an ML model from input data; and (2) inference, which applies the trained model to real-life situations. Because ML systems are overly reliant on quality data, the attacks to such systems can be defined with respect to the data processing pipeline. Adversaries may target different stages of the AI pipeline i.e. manipulating the training data collection, corrupting the model, or tampering with the outputs.

### SUMMARY OF THE INVENTION

Data poisoning attacks manipulate training data to guide the learning process towards a corrupted ML model and hence, to degrade classification accuracy or manipulate the output to the adversaries' needs. For example, attacks could be made against worm signature generation spam filters, DoS attack detection PDF malware classification, hand-written digit recognition, and sentiment analysis. The real-world data poisoning attacks include the manipulation of client data used in financial services, large-scale malicious attempts to skew Gmail spam filter classifiers, hacking hospital CT scans to generate false cancer images and an AI bot learning racist and offensive language from twitter users. This new wave of attacks can corrupt data-driven ML models to influence beliefs, attitudes, diagnoses and decision-making, with an increasingly direct impact on our day-to-day lives.

Defending against data poisoning attacks is challenging because the ML pipeline, including data collection, curation, labeling and training may not be completely controlled by the model owner. For example, the training data may be obtained from unreliable sources (e.g., crowdsourced or client devices' data) or the model may require frequent retraining to handle non-stationary input data. Moreover, ML models currently deployed at the edge, such as IoT devices, self-driving cars, drones, are increasingly sharing data to the cloud to update models and policies. Thus, an attacker may alter the training data either by inserting adversarial inputs into the existing training data (injection), possibly as a malicious user, or altering the training data directly (modification) by direct attacks or via an untrusted data collection component. Existing defense methods include training data filtering and robust ML algorithms that rely on the assumption that poisoning samples are typically out of the expected input distribution. Methods from robust statistics are resilient against noise but perform poorly on adversarial poisoned data.

Proposed defenses against data poisoning attacks can be divided into two categories: (1) data sanitization (i.e. filtering polluted samples before training); and (2) robust learning algorithms.

Data sanitization—Separating poisoned samples from normal samples can be achieved by effective out-of-distribution detection methods. A Reject on Negative Impact (RONI) method tries to identify the selected set of samples as poisoned or normal by comparing the performance of the model by training with and without the samples under test. An improvement in the performance indicates the selected samples are normal, or else they are assumed to be poisoned data. The main drawback of the RONI method is efficiency as depending on the size of the dataset and the percentage of poisoned samples, it may be difficult to train the model multiple times to detect poisoned vs. non-poisoned data.

Robust Learning Algorithms—Robust learning algorithms potentially rely on features generated by multiple models. Multiple classifier methods learn multiple ML models to apply bagging-based approaches to filter out poisoned samples. A bagging-based approach is an ensemble construction method, wherein each classifier in the ensemble is trained on a different bootstrap replicate of the training set.

The present invention discloses a secure ML pipeline to improve the robustness of ML models against poisoning attacks and utilizing data provenance as a tool. To be specific, two new components are added to the ML pipeline: (1) A data quality pre-processor, which filters out untrusted training data based on provenance derived features; and (2) An audit post-processor, which localizes the malicious source based on training dataset analysis using data provenance, which refers to the lineage of a data object and records the operations that led to its creation, origin, and manipulation.

### BRIEF DESCRIPTION OF THE DRAWINGS

FIG. 1 shows the data pipeline in video surveillance systems, use as an exemplary application of the present invention.

FIG. 2 shows possible threat points where data may be injected or maliciously altered in a typical ML training pipeline.

FIG. 3 shows an end-to-end ML system with the ML pipeline including the components of the present invention.

FIG. 4Error! Reference source not found. depicts the workflow of the data quality pre-processor component of the present invention.

FIG. 5 depicts the audit post-processor component of the present invention.

FIG. 6 shows clean and poisoned data items from two datasets used in an experimental validation of the present invention.

FIG. 7 shows exemplary results of the experimental validation of the present invention.

FIG. 8 is a diagram of one embodiment of a system configuration for supporting the present invention.

### DETAILED DESCRIPTION

The invention will be explained in terms of a vision-based ML use case, namely, smart city traffic management and public safety. The invention, however, is generic and should not be construed to be limited to vision use cases.

Video surveillance capability enables exciting new services for smart cities. The targeted applications include (1) Object (e.g. vehicle, pedestrian, road barrier, etc.) detection; (2) Vehicle detection and classification; (3) Crime prevention: license plate/vehicle recognition, accident prevention, safety violation detection; (4) Automated parking, including fee collection; and (5) Traffic congestion monitoring and real-time signal optimization. Smart city cameras may be shared by multiple public agencies such as police, fire, public work, etc. to develop and enforce safety policies.

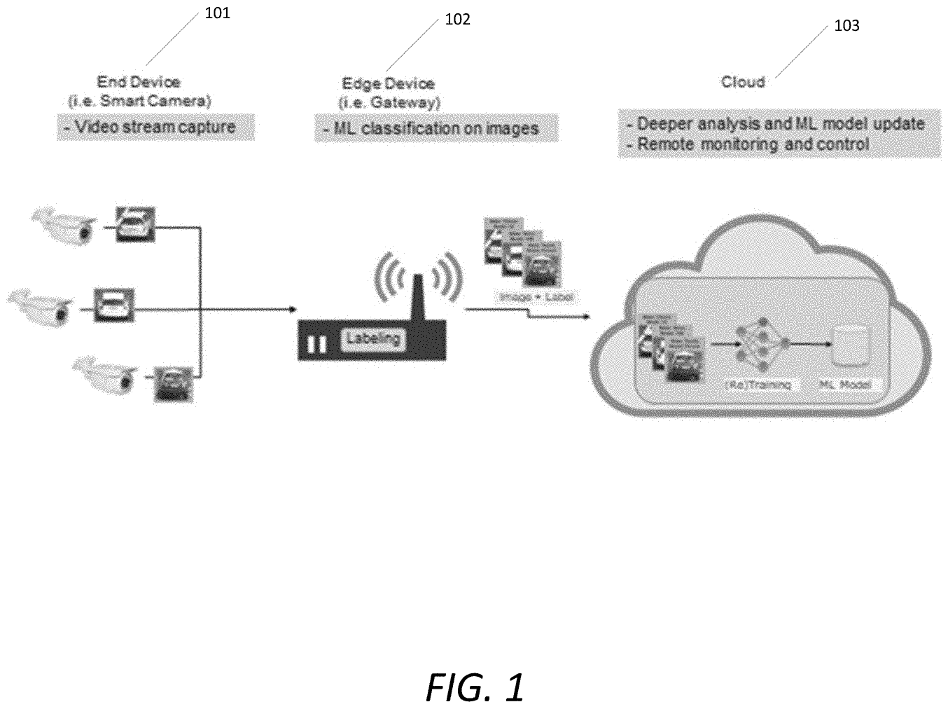

FIG. 1 shows the data pipeline in video surveillance systems. A network IP camera captures a video stream and sends the raw stream or extracted images to an edge device. ML image classification and detection are performed at the edge device which then send the images and inference results to cloud for second level data analytics and ML model retraining.

Because data poisoning attacks shift the ML class boundaries, the goal of an attacker may be to misdirect law enforcement agencies, for example, to evade detection in crimes or accidents, defraud parking fee payment or to cause serious damage by accidents via wrong object detection.

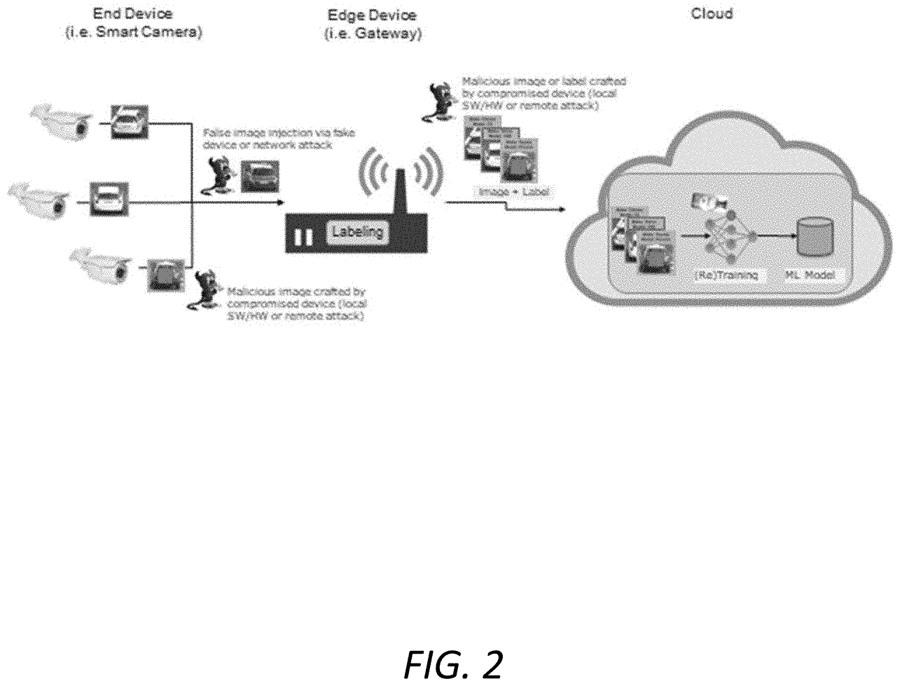

FIG. 2 shows possible threat points where data may be injected or maliciously altered. Software or remote (networked) adversaries may compromise an end/edge device irrespective of the device deployed in a secure or unsecure environment. Hardware adversaries are relevant when the camera is in an unsecured environment. Insider attacks have more serious consequences because insiders generally have deep system knowledge, authorized access to the debug architecture, provisioning, and even the ability to modify the design to introduce a Trojan Horse or back door. Thus, the end devices (i.e. data sources) may craft malicious images, the edge devices may inject or modify crafted images or flip labels, or an outside attacker may inject false images to pollute the training dataset and cause data poisoning attacks.

The present invention considers a ML system where data is generated by end devices, labeled by end or edge devices, and used to train a ML model in a cloud. The end and edge devices are assumed to be vulnerable to attacks and the training server is assumed to be trusted. An attacker may be characterized according to its goal, knowledge of the targeted system, and capability of manipulating the input data. We assume an attacker with the following goals and capabilities.

Attacker Goals—An availability violation compromises normal system functionality, e.g., by increasing the ML classification error. If the goal is Indiscriminate, the objective is to cause misclassification of any sample (to target any system user or protected service). If the goal is generic, the objective is to have a sample misclassified as any of the classes different from the true class.

Attacker Knowledge—if an attacked has perfect knowledge, it knows everything about the targeted system, including model class, training data/algorithm, hyper-parameters, parameters at epochs. If the attacked has limited knowledge, it generally knows the feature set and learning algorithm, but not the training data and parameters, even if the attacker can collect a substitute data set.

Attacker Capability—The attacker may inject false data, maliciously craft data, or flip the label. The attacker may collaborate with others but in any case, is able to poison at most K samples.

To defend against data poisoning attacks, the present invention uses a secure ML training pipeline including two new components: (1) a data quality pre-processor; and (2) an audit post-processor. Since data poisoning attack is caused by data manipulation, we propose tracking provenance of training data and use the contextual information for detection of poisonous data points and malicious sources.

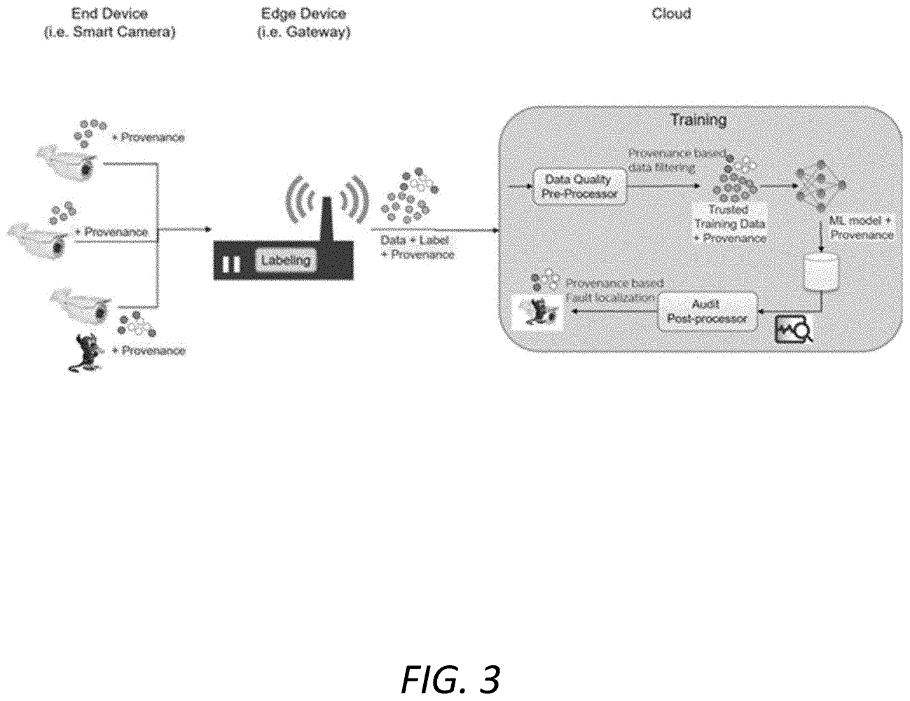

FIG. 3 shows an end-to-end ML system with the ML pipeline including the components of the present invention. End devices record and send provenance metadata (e.g. source ID, time, location, etc.) along with the actual training data. As the edge devices label incoming data, they also record relevant provenance metadata. Given the training data, along with data generation and labeling provenance, the training server at the cloud pro-actively assesses the data quality.

The data quality pre-processor component filters out untrusted, possibly poisonous, data by an anomaly detection-based outlier detection method using provenance as features. This feature enables the ML training performed on a trusted training dataset. If some poisonous samples, however, evade anomaly detection and a data poisoning attack is observed after model deployment, the audit post-processor component automates fault localization and recovery. In any case, the data quality pre-processor component raises the trustworthiness of training dataset. Given the input samples responsible for misclassification, the audit post-processor component tracks their sources and analyzes the impact of data produced by those sources on the ML model to identify malicious entities. To get the training dataset associated with a version of ML model, provenance metadata is also captured during training (e.g. dataset, features, algorithm, etc. used for training).

The pre- and post-processing components can be used independently but the user may make important considerations in choosing which to use. For example, post-processing algorithms are easy to apply to existing classifiers without retraining.

Provenance Specification—Contextual information is captured based on the requirements of the data quality pre-processor and audit post-processor components. In one embodiment of the invention, the following metadata and provenance is captured. A description of how the metadata is used in ML components follows.

Metadata about training data—For training data, this embodiment of the invention captures provenance for both data generation and labeling. Metadata may be captured during different stages of ML training pipeline. The training data provenance specification is as follows:

Provenance: <Operation{Data generation|labeling}, Actor, Process, Context>

Actor: <Device ID, Agent{sensor|human|SW|API}>

Process: <SW{Binary exec}|ML modelID}>

Context: <Time, Location>

Data Quality Pre-Processor Component

The data quality pre-processor component pro-actively assesses the quality of training dataset and removes untrusted, possibly poisoned, data to improve the robustness of ML training. The trustworthiness of a data point dᵢ, generated by Sᵢ, is measured from three dimensions and provenance metadata is utilized to compute them.

Believability of data processing entity (Tᵢ): A reputation management system manages trust score, Tᵢ, of data source/labeler. Tᵢ is associated with the device ID. This term can be derived using a Bayesian method, combining many relevant attributes of the training set source.

Data consistency over time: For a data source Sᵢ and time [t, t+1], in one embodiment of the invention, the following factors may be considered: (1) data rate, Rᵢ; (2) similarity among (distribution followed by) generated data values, P₁. The computation of Rᵢ and Pᵢ require data and timestamp.

Data consistency over neighboring data sources: At time t, similarity among (distribution followed by) data values generated by neighboring sources, Pₙ(t). This requires data and location metadata to compute this value.

In addition to a binary trusted vs. untrusted decision, Bayesian methods can also be applied to selectively weight the input data on a linear or nonlinear scale. This enables the largest data set while giving emphasis to the most trusted input data. This can be particularly valuable when combining large data sets from multiple sources which have varying degrees of provenance assurance established with objective technical means and subjective assessments.

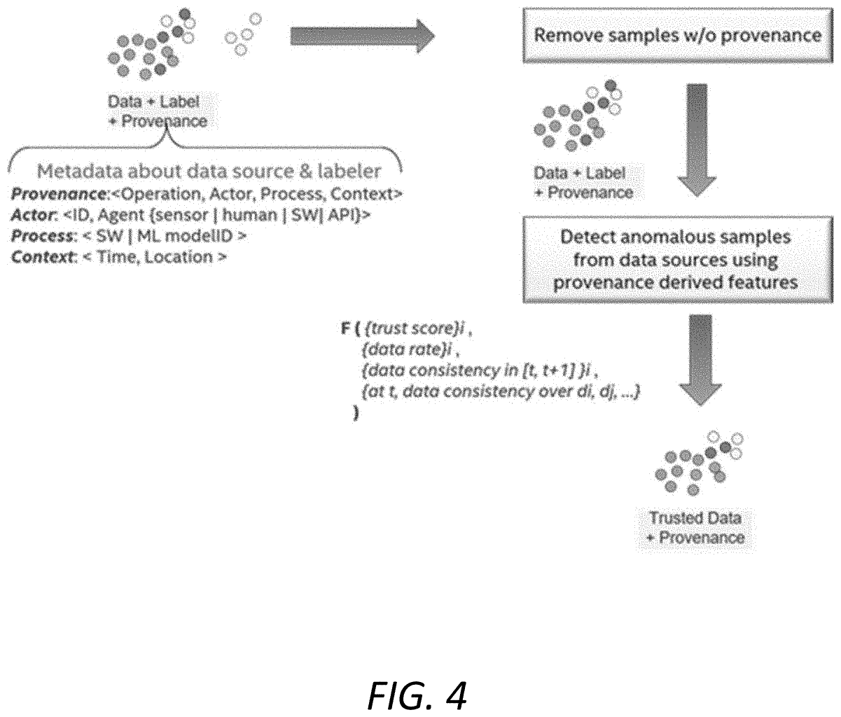

FIG. 4 depicts the workflow of the data quality pre-processor component. Given a training dataset, any samples without authenticated provenance are removed, resulting into a dataset D, which is partitioned into smaller disjoint subsets D={D₁, D₂, . . . , Dₙ} where Dᵢᵢ is the micro-dataset starting at time (t−1)*g and g is the granularity for each micro-dataset. For each data point in Dᵢ, the values <Tᵢ, Rᵢ, Pᵢ, Pₙ(t)> are computed and considered as features associated with the data. Then, an anomaly detection algorithm is executed on D to detect outliers and identify them as untrusted data points.

Audit Post-Processor Component: Data+Model Provenance-Based Fault Localization

Given the misclassified testing samples and corresponding ground truth, this component identifies the malicious entities and repairs the learning system. It reduces the manual effort of administrators by utilizing provenance to track the data sources and detect the set of poisoned training data samples.

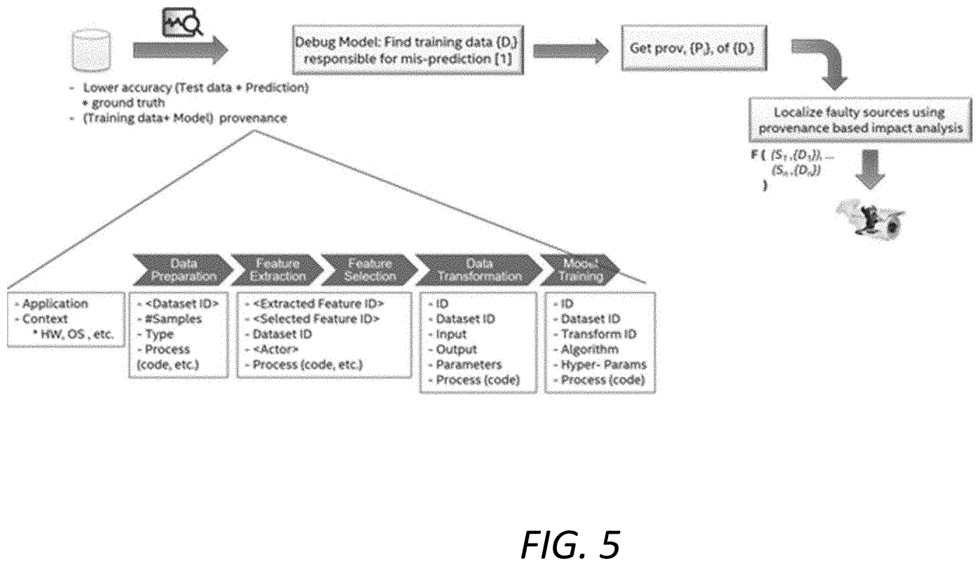

As shown in FIG. 5, the audit post-processor component uses model provenance to get the associated training data set and may use auxiliary mechanisms to find the training samples responsible for misclassification.

As the provenance (e.g. data sources), {S₁,S₂, . . . ,Sₙ} of the training samples are tracked, the training dataset is partitioned into {D₁, D₂, . . . , Dₙ}, where Dᵢ is the dataset generated by Sᵢ. The impact of {Dᵢ} on the trained model is analyzed and the training samples are “unlearned” if they degrade the ML classification accuracy. In some embodiments of the invention, existing mechanisms, such as using group influence functions, model retraining with and without a subset of training data, etc. may be leveraged and/or new algorithms for better performance may be used.

Workflows such as Federated Learning, Reinforcement Learning and transfer Learning include training at the network edge or in the edge devices themselves. For these ML systems the audit post-processor component can run along with the training feedback to provide provenance to maintain the trustworthiness of the ML application. This can also serve to control the gain of the feedback which can enable the customer to choose how quickly the algorithm responds to new inputs vs. how stable it is.

Provenance security and efficiency—The provenance collection and transmission must achieve the security guarantees of (i) integrity, and (ii) non-repudiation. The present invention protects provenance records using hash and digital signature as:
<data, P₁, P₂, . . . , Pₙ, sign(hash(data, P₁, P₂, . . . , Pₙ), ecdsa_pub_key)
   where P₁,P₂, . . . , Pₙ are metadata included in a provenance record. A TEE or light-weight co-processor, hardware extension, etc. may be used to provide the security guarantee of data provenance collection, even when the device is untrusted.

For performance and storage efficiency, a session-based data and provenance collection may be used (i.e., to attach one provenance record for a batch of data from a source).

Simulation Results

The effectiveness of the present invention was simulated, assuming a backdoor attack wherein a backdoor pattern is inserted in the training samples and labels are flipped to generate poisoned samples. The attacker introduces backdoor samples into the training data, Dₜᵣₐᵢₙ, in such a manner that the accuracy of the resulting trained model measured on a held-out validation set does not reduce relative to that of an honestly trained model. Further, for inputs containing a backdoor trigger, the output predictions will be different from those of the honestly trained model.

MNIST and CIFAR10 datasets were used to study the backdoor data poisoning attack on image classification task. The training set, Dataₜᵣₐᵢₙ contains all the original clean samples, Dataₜᵣₐᵢₙ^{clean}, along with additional backdoored (BD) training samples, Dataₜᵣₐᵢₙ^{BD}.

Dₜᵣₐᵢₙ=Dₜᵣₐᵢₙ^{clean} ∪ Dₜᵣₐᵢₙ^{BD}

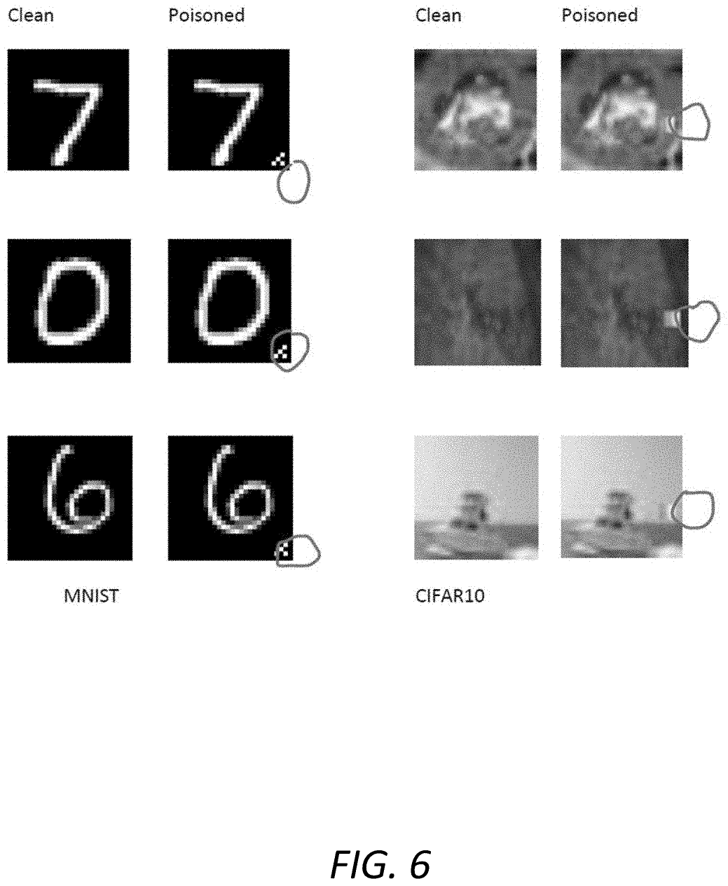

A clean held-out validation set, Dataᵥₐₗ^{clean}, from which was generated additional backdoored samples, Dataᵥₐₗ^{BD}, was used to measure the effectiveness of the attack and that of the defense of the invention. The attack patterns used were a four-pixel backdoor pattern (for the MNIST dataset) and a 4×4 square pattern (for the CIFAR dataset). For both the datasets, a poisoned sample class label is reassigned to the next class (in a circular count). Clean and poisoned data items from each dataset are shown in FIG. 6. The effect of varying the percentage of poisoned samples in Dₜᵣₐᵢₙ was studied. The ResNet-20 architecture was used for experiments with RVC 10 Tech Report: Defending against Machine Learning Poisoning Attacks using Data Provenance.

The ResNet-20 architecture was used for experiments with the CIFAR10 dataset, and a simple convolutional neural network (SCNN) architecture consisting of two convolutional layers followed by two dense layers was used for experiments with MNIST dataset.

The effectiveness of poisoning attacks on DNNs was demonstrated. The experiments included different percentages of backdoor samples included in the training set. For a poisoned sample, the classification outcome is considered ‘correct’ if it matches the target poisoned label, not the original clean label. Thus, high accuracy on the poisoned dataset indicates that the poisoning attack (with backdoor patterns) has been successful in making the network misclassify the poisoned set while maintaining high accuracy for the clean set.

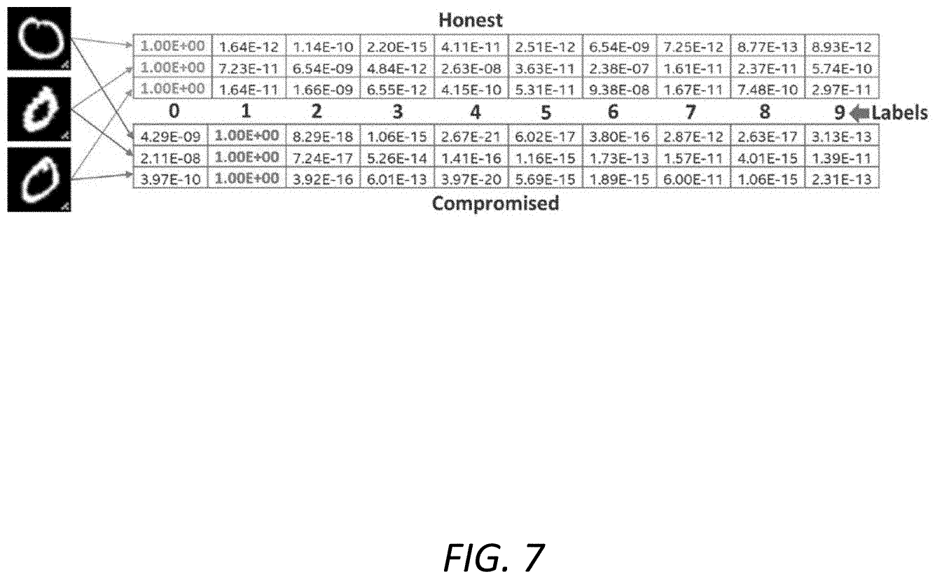

In FIG. 7, the softmax values from honest (no poisoned data) and compromised (with poisoned data) DNN models for digit-0 are presented. An honest model classifies poisoned test data correctly (as digit 0), whereas the compromised model misclassifies the poisoned test sample (in this case digit-0 as digit-1) according to the targeted data poisoning attack.

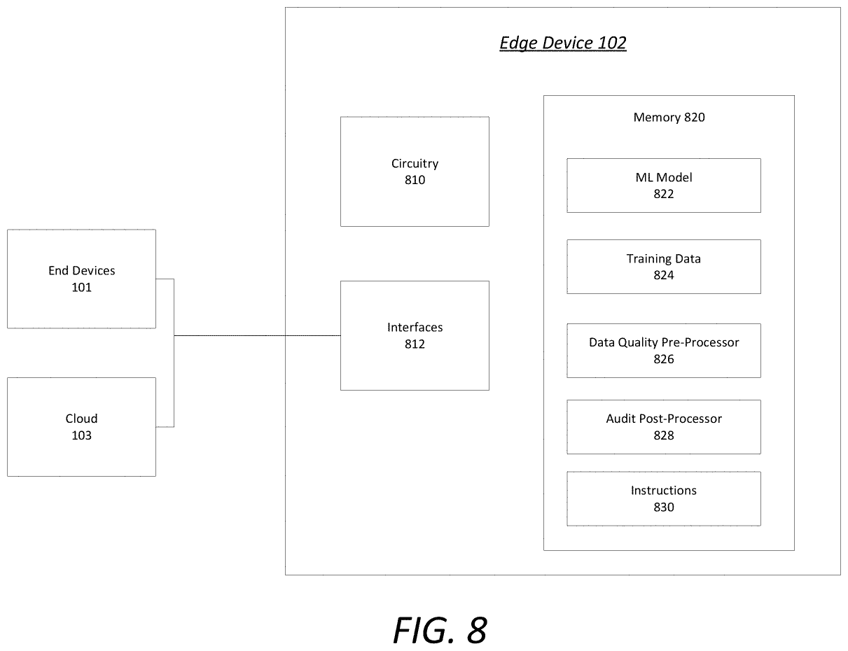

The components of a typical ML training pipeline shown in FIG. 1 may be implemented according to the present disclosure as shown in FIG. 8. Edge device 102 may be embodied by any number or type of computing systems, such as a server, a workstation, a laptop, a virtualized computing system, an edge computing device, or the like. Additionally, edge device 102 may be an embedded system such as a deep learning accelerator card, a processor with deep learning acceleration, a neural compute stick, or the like. In some implementations, the edge device 102 comprises a System on a Chip (SoC), while in other implementations, the edge device 102 includes a printed circuit board or a chip package with two or more discrete components. Furthermore, edge device 102 can employ any of a variety of types of “models” arranged to infer some result, classification, or characteristic based on inputs.

The edge device 102 may include circuitry 810 and memory 820. The memory 820 may store input data, output data and instructions, including instruction for the data quality pre-processor and the audit post-processor components of the present invention. During operation, circuitry 810 can execute instructions for the data quality pre-processor component 826 and the audit post-processor component 828 to generate ML model 822 from training data 824. Sometimes ML model 822 may be generated from training data 824 as described with respect to the preceding embodiments. In some such embodiments, training data 824 may include training data, and circuitry 810 may execute instructions 830 to generate ML model 822. For example, training data 824 may include a plurality of pictures labeled as including cats or not including cats, captured from edge devices 101. In such examples, the plurality of pictures can be used to generate a ML model that can infer whether or not a picture includes cats, and the ML model can be provided as output data and stored on cloud 103. In many such embodiments, circuitry 810 may execute instructions 830 and ML model 822 to classify input data and provide the classification of the input data as output data. For example, input data may include a picture and the output data may classify the picture as either including a cat or not including a cat. In various such embodiments, the input data may include a testing data set (e.g., pictures and their classification), and circuitry 810 may execute instructions 830 to evaluate performance of the ML model 822 with the testing data set and provide an indication of the evaluation as output data.

Edge device 102 can also include one or more interface 812. Interfaces 812 can couple to one or more devices, such as devices external to edge device 102. For example, end devices 101 and cloud 103. In general, interfaces 812 can include a hardware interface or controller arranged to couple to an interconnect (e.g., wired, wireless, or the like) to couple the edge device 102 to other devices or systems. For example, the interfaces 812 can comprise processing circuits arranged to transmit and/or receive information elements via the interconnect to communicate and/or receive information elements (e.g. including data, control signals, or the like) between other devices also coupled to the interconnect. In some examples, interfaces 812 can be arranged to couple to an interface compliant with any of a variety of standards. In some examples, interfaces 812 can be arranged to couple to an Ethernet interconnect, a cellular interconnect, a universal serial bus (USB) interconnect, a peripheral component interconnect (PCI), or the like. In some examples, edge device 102 can include multiple interfaces, for example, to couple to different devices over different interconnects.

In general, end devices 101 can be any devices arranged to provide signals, as inputs, to edge device 102. With some examples, end devices 101 could be any number and type of sensors. During operation, circuitry 810 can execute instructions 830 to receive signals from these end devices via interfaces 812. Circuitry 810, in executing instructions 830 could store the received signals as input data. Alternatively, circuitry 810, in executing instructions 830 could generate input data based on the signals (e.g., by applying some processing to the raw signals received from the sensors via the interfaces 812). As another example, circuitry 810 can execute instructions 830 to receive information from other computing devices including indications of input data. With some examples, any one or more of end devices 101, cloud 103 and/or any other computing device could be packaged with edge device 102. Examples are not limited in this context.

As introduced above, the present disclosure provides architectures, apparatuses and methods arranged to mitigate or reduce data poisoning attacks to systems employing AI, such as ML model 822. Edge device 102 is thus arranged and positioned to mitigate or reduce such attacks.

In general, circuitry 810 is representative of hardware, such as a conventional central processing unit (CPU), an application specific integrated circuit (ASIC), a field programmable gate array (FPGA), or other logic. For example, circuitry 810 can implement a graphics processing unit (GPU) or accelerator logic. In some examples, circuitry 810 can be a processor with multiple cores where one or more of the cores are arranged to process AI instructions. These examples are provided for purposes of clarity and convenience and not for limitation.

Circuitry 810 can include an instruction set (not shown) or can comply with any number of instruction set architectures, such as, for example, the x86 architecture. This instruction set can be an a 32-bit instruction set, a 64-bit instruction set. Additionally, the instructions set can use low precision arithmetic, such as, half-precision, bflaot16 floating-point format, or the like. Examples are not limited in this context.

Memory 820 can be based on any of a wide variety of information storage technologies. For example, memory 820 can be based on volatile technologies requiring the uninterrupted provision of electric power or non-volatile technologies that do not require and possibly including technologies entailing the use of machine-readable storage media that may or may not be removable. Thus, each of these storages may include any of a wide variety of types (or combination of types) of storage devices, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array).

The invention has been described in terms of specific examples of applications, architecture and components, and their arrangement. It should be realized that variations of specific examples described herein fall within the intended scope of the invention, which defined is by the claims which follow.

We claim:

1. One or more non-transitory computer readable storage media-comprising, instructions that when executed by processing circuitry cause the processing circuitry to:
receive training data captured from one or more input devices;
filter the training data, based on provenance-derived features, to identify untrusted untrusted training data from the training data, the untrusted training data a subset of the training data;
train a machine learning model with modified training data comprising the training data without the untrusted training data;
identify malicious training data based on misclassifications by the machine learning model, the malicious training data a subset of the modified training data; and
further training the machine learning model with additionally modified training data comprising the modified training data without the malicious training data.
